(19) United States
(12) Patent Application Publication
(10) Pub. No.: US 2012/0073448 A1
(43) Pub. Date: Mar. 29, 2012

(54) Coffee maker with computerized steeping control

(76) Inventors: Royce H. Husted, Forest, VA (US); Joel P. Husted, Forest, VA (US)

(21) Appl. No.: 12/924,248

(22) Filed: Sep. 23, 2010

(51) Int. Cl. A47J 31/44; A47J 31/54

(52) U.S. Cl. 99/283; 99/288

(57) ABSTRACT

A computer controlled coffee maker includes a filter basket for holding coffee grinds above a water filled carafe. A motorized dunking mechanism controls the movement of said filter basket into and out of the water in said carafe for steeping and draining said coffee grinds. The dunking cycles and water temperature are determined by a preprogrammed computer and user selected inputs to provide coffee brewed with minimal exposure of the grinds to high temperatures. A breakaway connection is provided between the dunking mechanism and the filter basket.

This invention is an improvement of the inventor's U.S. Pat. No. 6,135,010, the disclosure of which is incorporated by reference herein.

### BACKGROUND OF THE INVENTION AND PRIOR ART

This invention relates generally to devices for brewing coffee and particularly to a machine which delivers a superior coffee flavor by extracting substantially only the desirable substances from the coffee grinds. Most coffee brewing machines use very hot water to extract the coffee flavorings which also results in undesirable acids being extracted. The acids cause a bitter taste and some people may even experience nausea after drinking highly acidic coffee.

There are many hot water processes for brewing coffee. Drip brewing is the most popular because it is fast and relatively automatic. Despite its popularity, the drip brewing process results in the extraction of undesirable acids from the coffee grinds due to the high temperature of the water. Drip brewers generally use a geyser pump to lift and dispense hot water over coffee grinds held in a filter basket. Boiled water, which is required to activate the geyser pump, is delivered to the coffee grinds. Since the water is passed through the grinds only once, the water needs to be hot to extract a full flavored coffee. The filter basket is located above the carafe and drip coffee makers are consequently quite tall, which adds to the storage problem. Also, the steam emitted as a result of boiling water may be detrimental to kitchen cabinets and the like.

The French method of coffee making steeps the coffee grinds in hot water. The prior art includes many such French type coffee making machines and patents thereon. Most are manually operated and use a cylindrical carafe and matching piston-like filter that seals against the carafe wall. After steeping, the filter is manually pressed to the bottom of the carafe to separate the grinds from the coffee. The coffee produced is full flavored since the grinds are completely immersed in the water to produce full extraction of the coffee flavorings. Traditionally, French brewed coffee is immediately served after brewing and has achieved an enviable reputation for taste.

The Dutch brewing method uses cold water steeping which produces coffee of rich smooth taste and low acidity. With this method, the coffee grinds are steeped in a container of cool water for a considerable time period, generally at least 8 hours. The steeped coffee is subsequently filtered into a pot or carafe and later heated for consumption. While the result is an excellent, smooth tasting coffee of low acidity, the process is cumbersome, time consuming and completely manual.

The inventor's computer controlled coffee maker in U.S. Pat. No. 6,135,010, disclosed a warm steeping system that (within the time period selected by the user) automatically extracted full flavorings from the coffee grinds, while minimizing acidic content, by steeping the coffee grinds in warm water, the temperature of which was dependent upon the time period selected. After the extraction process, the coffee was rapidly raised to drinking temperature. The filter basket was held in the water by means of a spring loaded mechanism that was triggered to release the filter basket as determined by the computer program.

The references cited in the inventor's prior patent provide further examples of prior art coffee making devices. U.S. Pat. No. 2,566,914 disclosed a single bowl coffee maker with a spring loaded filter basket that was released by a temperature sensing mechanism and included a magnetically operated latching mechanism.

U.S. Pat. No. 3,279,351 held the coffee in a spring loaded filter basket above the water in the carafe until a preselected temperature was attained, at which time the filter basket was released and driven into the coffee by a motor driven gear arrangement.

U.S. Pat. No. 4,401,014 used a filter basket that included a flotation arrangement. The coffee-grinds-filled filter basket was secured in the carafe and the filter basket held in the water by spring loading. After heating for the selected time, the filter basket was released by a thermal latch, thus permitting the basket to float in the carafe with the coffee grounds out of the water. The arrangement also enabled the carafe to be used to decant the coffee with the filter basket and grounds still in place in the carafe.

U.S. Pat. No. 5,027,696 included a motor operated geared filter basket that was raised after steeping of the coffee. The patent also described an alternative arrangement wherein the filter basket would be oscillated within the carafe to accelerate steeping of the coffee grinds.

### SUMMARY OF THE INVENTION

The present invention improves upon the inventors' patented coffee maker in a number of ways. It features a warm steeping process that involves repetitive dunking of the filter basket and coffee grinds, that is inserting them into the water for steeping and removing them from the water for draining, to improve the extraction of the coffee flavorings with minimal acidity, all within the time constraints established by the user. The invention discloses a mechanical dunking arrangement for moving the filter basket (and coffee grinds) into the carafe for steeping and raising the filter basket out of the carafe for draining. The dunking cycles are performed according to a schedule determined by a preprogrammed computer. At the end of the brewing process, the filter basket is lifted clear of the carafe and the coffee brought to drinking temperature. A breakaway release is provided between the filter basket and the dunking mechanism should the carafe be inadvertently removed before the filter basket has been raised out of the carafe.

It will be appreciated that, to achieve the full benefits of the warm steeping process, coffee preparation should be started well before the desired consumption time. However to meet the varying needs of different users, a number of brewing options are provided by the invention. The user may select the number of cups of coffee, the coffee ready time and slow or fast brewing. To start, the user fills the carafe with water and the filter basket with coffee grinds. The invention's preprogrammed computer activates the heating unit and lowers the filter basket into the water-filled carafe at the appropriate time, in response to the user's selection. At predetermined times during the brewing process, dependent upon the overall time selected therefor, the computer activates the dunking mechanism to raise the filter basket out of the water in the carafe, allowing water in the filter basket to drain back into the carafe and then lowers the filter basket back into the water to continue the steeping of the coffee grinds. Each draining-and-steeping constitutes a dunking cycle. Using gravity, the dunking cycles provide a pumping action of the water through the filter basket, exchanging the stronger brewed water inside the filter basket for the weaker brewed water inside the carafe. Simply oscillating the basket within the water in the carafe does not achieve this effect, and due to the resistance to flow added by the paper filter element, hardly offers any effect at all.

In practice, the invention contemplates a maximum time for brewing, with a corresponding number of dunking cycles, to produce optimum flavor extraction with minimal acidity and scales down the number of dunking cycles to accommodate user selected shorter brewing periods. Since the dunking cycles accelerate the extraction of the desirable attributes of the coffee grinds, the brewing times and as well as the quantity of coffee grinds used may be correspondingly reduced as compared with similar brewing without the dunking cycles of the invention. Similarly, the temperature rise during brewing is adjusted to the shorter brewing times. Just before the selected coffee ready time, the filter basket is lifted out of the water and the coffee is raised to serving temperature and held in a keep warm mode. Thus the water steeping temperature is a function of the start time and the coffee ready time. With longer brewing times, lower temperatures are used to achieve full flavor extraction resulting in lower acidity and smoother flavored coffee.

### OBJECTS OF THE INVENTION

A principal object of the invention is to provide a novel coffee maker.

Another object of the invention is to provide an improved user controlled computerized automatic coffee maker capable of brewing at a variety of relatively low temperatures.

A further object of the invention is to provide a novel coffee maker that enables a user to brew coffee in a number of different ways for selection of the best way for the type of coffee being used and the user's taste.

### BRIEF DESCRIPTION OF THE DRAWINGS

These and other objects and advantages of the invention will be apparent upon reading the following description in conjunction with the drawings in which:

FIG. 1 is a front view of a coffee maker of the invention;

FIG. 2 is a sectional view of FIG. 1;

FIG. 3 is a top view of the filter basket of the invention;

FIG. 4 is partially broken away side view of FIG. 3;

FIG. 5 is a plan view of a snap on coffee filter cap for the filter basket;

FIG. 6 is a cross section of the coffee filter cap, taken along line 6-6 of FIG. 5;

FIG. 7 depicts a flat type filter element;

FIG. 8 illustrates a typical time/temperature curve for coffee brewing; and

FIG. 9 shows a time diagram for brewing based upon a particular set of user inputs.

### DETAILED DESCRIPTION OF THE INVENTION

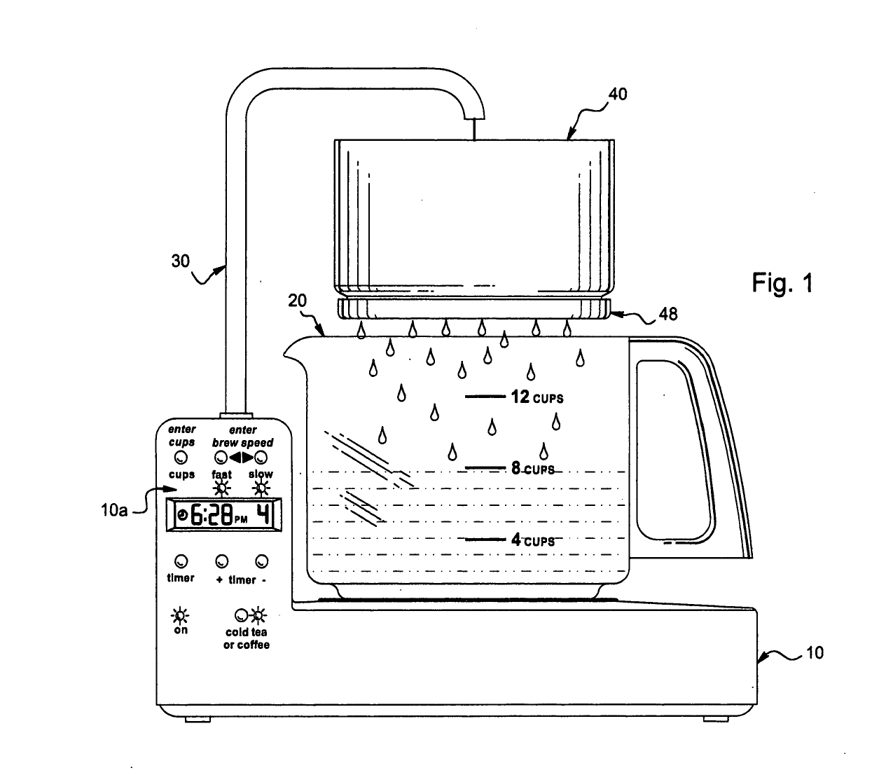

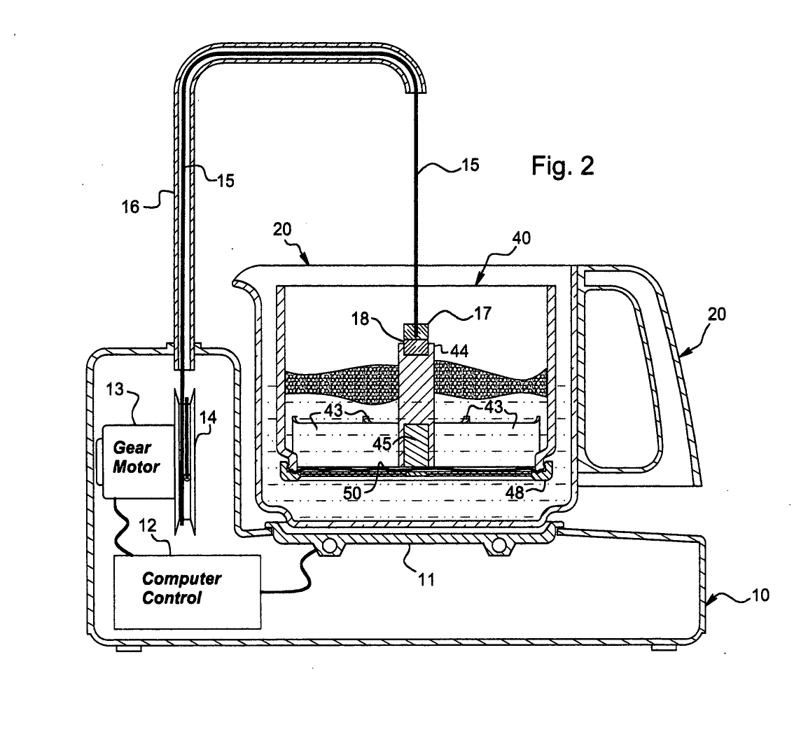

Referring to FIGS. 1 and 2, a base 10 supports a heating plate 11 for heating water in a carafe 20. A control panel 10a receives user inputs such as the number of cups of water in the carafe 20, the time coffee is desired, and coffee style preference. A computer control block 12 in base 10 includes a preprogrammed computer and appropriate software (not shown) for controlling the application of power to heating plate 11 and the operation of a gear motor 13 for raising and lowering a filter basket 40 into and out of water in carafe 20. While heating plate 11 is shown as a part of the base 10, the heating element could be part of the carafe itself, as is commonly done in water heating carafes, to provide for more rapid heating of the water. A conventional power supply for developing operating potentials for the various elements of the invention is not illustrated for the sake of clarity. The software includes programs for establishing start and stop times for the coffee maker, providing appropriate displays for the user, performing dunking cycles and controlling temperature of the brewing process, as will be discussed.

A gear motor 13 drives a pulley 14, about which a cable 15 is wound. A J-shaped tubular support structure 16 is attached to base 10 and overhangs the center of carafe 20. The free end of cable 15 passes through tubular support 16 and is attached to a magnet 17 that engages a magnetic insert 18 that is embedded in, or otherwise secured to, the top of a center post 44 of basket 40.

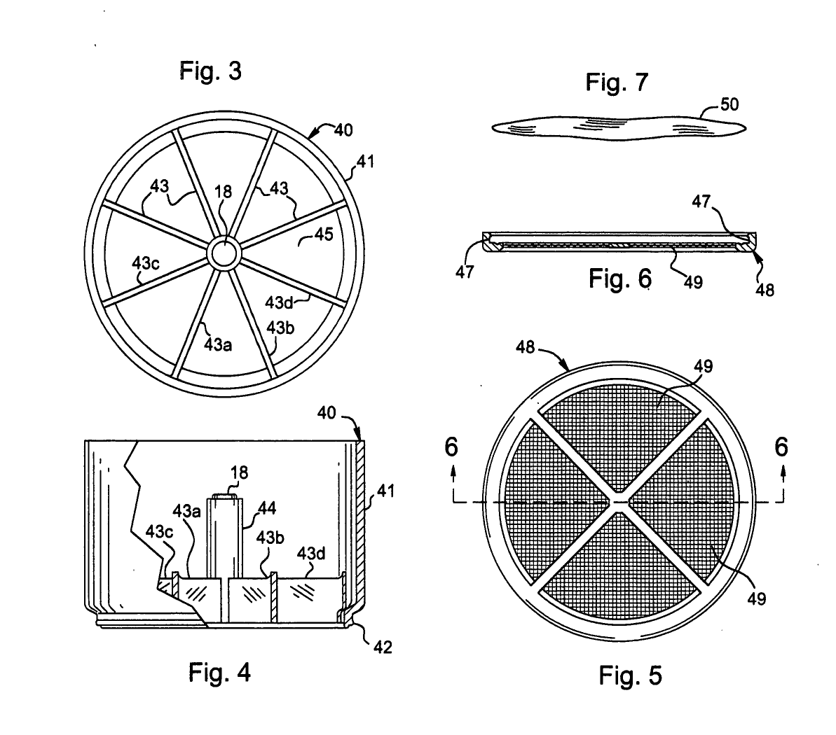

As best shown in FIGS. 3-7, filter basket 40 has a cylindrical wall 41 and an open top and bottom. A circumferential lip 42 at the bottom is engageable with a corresponding circumferential groove 47 in a snap-on cap 48 that has a fine screen 49 which allows the machine to be used with or without a paper filter 50. The choice to not use a paper filter would be preferred when making tea which does not produce the fine dust that coffee grinds do, or when paper filters have run out but coffee is still desired. A number of radially extending vanes 43 connect a center post 44 of the filter basket with cylindrical wall 41, with vanes 43a-43d specifically shown in the break away view of FIG. 4. These vanes serve to break up the floating coffee grinds, which otherwise tend to clump together at the surface of the water within the basket, as the level of water in the basket passes by the vanes and drains through the filter during each dunking cycle. Such vanes could take many shapes such as a number of fingers or rods and function equally well, all such variants being characterized as “inner features” of the filter basket. Visible in FIG. 2, a steel weight 45 is embedded in the lower section of post 44. This weight helps the filter basket to sink immediately upon dunking, because it takes a short while for the water to pass through the paper filter during which time the filter basket would otherwise be buoyant.

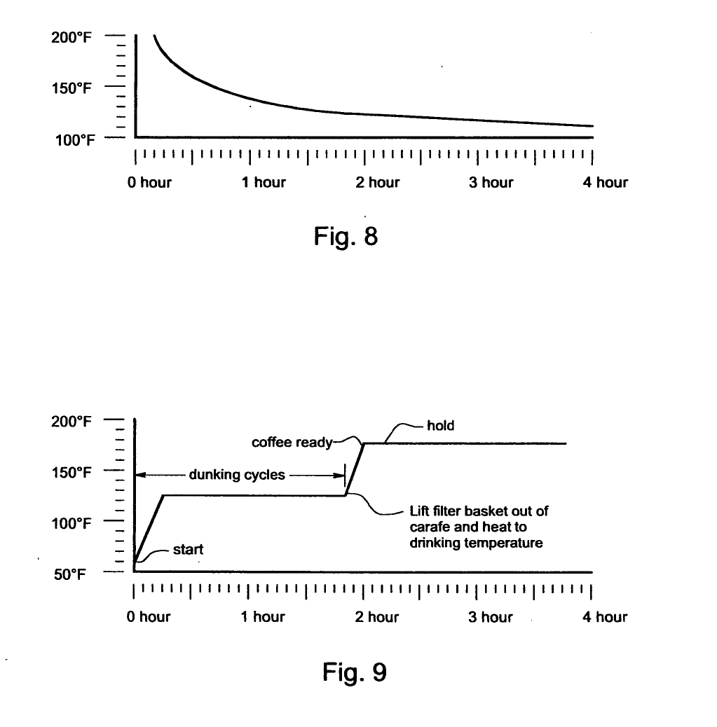

The ideal temperature for steeping coffee within a given time period is a relationship that can be determined by simple laboratory tests. Such tests are performed by heating a standard ratio of coffee grinds and water to specific steeping temperatures to determine the time period to achieve peak flavor. The procedures are performed for a range of temperatures until a complete set of data is obtained. FIG. 8 illustrates the results of a set of tests for a full range of time and temperatures, whereas FIG. 9 illustrates a typical curve for a brewing time of two hours. Qualitatively, it has been found that the coffee flavor is not notably improved by steeping times in excess of four hours. In the preferred embodiment of the invention, a maximum steeping time of four hours has been selected. The computer will inhibit commencement of steeping until four hours before the coffee ready time, when more than four hours is available, based upon the user selection. During the brewing period, dunking cycles are performed, with the number and frequency of such cycles being a function of the brewing time selected. For example, if the timer is set for the coffee to be ready in four hours, a typical dunking cycle would consist of steeping for 4 minutes and draining for 15 seconds. Approximately 50 dunking cycles would be performed at a relatively low steeping temperature, followed by raising of the basket near the end of the four hours and then heating up to drinking temperature, just prior to the coffee ready time. For fast brewing within an overall time of fifteen minutes for example, fewer dunking cycles would be performed at a higher frequency as the water temperature is steadily increased to the coffee ready temperature. Longer brewing times permit lower brewing temperatures with less frequent dunking cycles in order to provide a fully flavored coffee with lower acidity and better quality of flavor compared with shorter brewing times. Thus the longer the brewing time, the greater the attained benefits of the invention.

In use, a flat filter 50 of fibrous material is secured between cap 48 and the bottom of filter basket 40, with the screen 49 providing for two-way passage of water through the filter 50. The user fills the carafe 20 with water to the desired coffee cup level, as indicated by the fill marks on the carafe, and fills the filter basket with a corresponding amount of coffee grinds. The filter basket is then suspended from magnet 17 and the appropriate entries, corresponding to the number of cups of water in the carafe and the user's preferences, are inputted via the control panel 10a. The brewing process commences with the gear motor 13 being energized to lower the filter basket 40 into the carafe 20, thus immersing the coffee grinds in the water and, assuming a fast brewing time, heat being applied by the heating plate 11. The gear motor 13 is activated to raise the filter basket and coffee grinds completely out of the water and permit the liquid contents thereof to drain back through filter 50 to the carafe for respective time intervals determined by the computer, as discussed above. The gear motor is again activated to lower the filter basket back into the water to continue steeping of the coffee grinds. The dunking cycle, i.e., the raising and lowering of the filter basket, is repeated multiple times as determined by the computer and the overall brewing time as determined by the user.

The dunking process which typically will comprise a draining period of 15 seconds and a soaking (steeping) period of 1-5 minutes provides a simple gravity pumping action to move the relatively stronger coffee flavored water in the filter basket into the weaker surrounding water in the carafe and, in conjunction with the inner features of the filter basket, break up and mix the coffee grinds to more thoroughly expose all of the surface of the coffee grinds to the water. The result is that the desirable attributes of the coffee grinds are extracted more effectively and at lower temperatures during the brewing process.

To further illustrate the application of the invention, the following typical user selections are illustrated after filling the carafe with the desired amount of water, attaching the filter basket (filled with the appropriate amount of coffee grinds) to the dunking mechanism cable, and entering the number of cups of water in the carafe.

For FAST BREW immediately, the user presses the FAST BREW button. The computer immediately heats the water to the coffee serving temperature of approximately 175 degrees while performing dunk cycles. When the coffee ready temperature is reached, the filter basket is raised from the carafe and the heating unit is automatically switched to a Keep Warm mode, with the indicator light showing that the coffee is ready.

For TIMED FAST BREW, the user inputs the coffee ready time on the TIMER and presses the FAST BREW button. The computer will activate the brewing process approximately twenty minutes before the coffee ready time, with the sequence above being followed.

For SLOW BREW immediately, the user presses the BREW SLOW button. Dunk cycling begins as the water is heated to 140 degrees and continues while the water is held at that temperature. After one hour, the filter basket is raised from the carafe, the coffee temperature is then raised to the drinking temperature of 175 degrees and held there, and the indicator light shows that the coffee is ready.

For TIMED SLOW BREW, the user inputs the coffee ready time on the TIMER and presses the SLOW BREW button. The SLOW BREW process commences about four hours before the coffee ready time with the water being heated and held at 110 degrees while dunking cycles are performed until just before the coffee ready time, when the filter basket is raised from the carafe, the coffee temperature is then raised to the drinking temperature of 175 degrees and held there, and the indicator light shows that the coffee is ready.

What has been described is a novel coffee maker that extracts the desirable flavors from the coffee grinds with minimal acidity by enhancing the exposure of the coffee grinds to low temperature steeping by incorporating dunking cycles in the brewing process. It is recognized that numerous changes to the described embodiment of the invention will be apparent to those skilled in the art without departing from its true spirit and scope. The invention is to be limited only as defined in the claims.

1. A coffee maker comprising:
a carafe for holding water and brewed coffee;
a heat source for heating said water in said carafe;
a filter basket for holding coffee grinds while permitting said water to flow into and out of said filter basket into contact with said coffee grinds;
a dunking mechanism for performing dunking cycles comprising lowering said filter basket and said coffee grinds into said water for a first steeping time period and raising said filter basket out of said water for a second draining time period; and
a preprogrammed computer for automatically controlling the energy supplied by said heat source and automatically controlling said dunking cycles in accordance with a time-based schedule including:
a steeping temperature and a steeping duration;
a cycle time for said dunking mechanism;
the number of dunking cycles;
a coffee ready temperature; and
said time-based schedule being automatically determined by said computer based upon selected inputs from a user.

2. The coffee maker of claim 1, wherein said dunking mechanism comprises:
a motor operated under control of said computer; and
a structure, including a flexible connector between said motor and said filter basket, for supporting said filter basket for movement into and out of the water in said carafe.

3. The coffee maker of claim 2, further including a breakaway connection between said flexible connector and said filter basket.

4. The coffee maker of claim 3, wherein said breakaway connection is magnetic.

5. The coffee maker of claim 1, wherein said filter basket includes a plurality of inner features for breaking apart said coffee grinds during a portion of said dunking cycle.

6. The coffee maker of claim 1, wherein a flat disposable filter is removably retained within said filter basket.

7. A coffee maker comprising:
a carafe for holding water and brewed coffee;
a heat source for heating said water in said carafe;
a filter basket for holding coffee grinds and permitting said water to flow into and out of said filter basket into contact with said coffee grinds;
a dunking mechanism for performing dunking cycles comprising lowering said filter basket and said coffee grinds into said water and raising said filter basket out of said water;
said dunking mechanism comprising;
a motor operated under control of said computer; and a structure, including a flexible connection between said motor and said filter basket, for supporting said filter basket above said carafe for movement into and out of said carafe; and
a preprogrammed computer for automatically controlling the energy supplied by said heat source and automatically controlling said dunking cycles in accordance with a time-based schedule including:
a steeping temperature and a steeping duration;
a cycle time for said dunking mechanism;
the number of cycles for said dunking mechanism;
a coffee ready temperature; and
said time-based schedule being automatically determined by said computer based upon selected inputs from a user.

8. A coffee maker of the type including a carafe for holding water in which a filter basket of coffee grinds is immersed for steeping, a heating element for heating said water, and a pre programmed computer for controlling the steeping time and the operation of said heating element for limiting hot water steeping to avoid extraction of undesirable attributes of the coffee grinds and for lifting said filter basket from said carafe upon completion of steeping; the improvement, comprising:
providing a dunking mechanism for performing dunking cycles each comprising lowering said filter basket into said water for steeping and removing said filter basket from said water for draining; and
establishing the number of dunking cycles based upon selected inputs of the user.
